(19) United States
(12) Patent Application Publication
(10) Pub. No.: US 2004/0059070 A1
(43) Pub. Date: Mar. 25, 2004

(54) Process and apparatus for controlling molecular weight distribution and short chain branching for olefin polymers

(76) Inventors: William M. Whitte, Bartlesville, OK (US); Steven J. Secora, Bartlesville, OK (US); Rebecca L. Jones, Katy, TX (US)

Correspondence Address: MCANDREWS HELD & MALLOY, LTD, 500 WEST MADISON STREET, SUITE 3400, CHICAGO, IL, 60661

(21) Appl. No.: 10/441,408

(22) Filed: May 20, 2003

Related U.S. Application Data
(60) Provisional application No. 60/412,070, filed on Sep. 19, 2002.

(51) Int. Cl. C08F 2/00

(52) U.S. Cl. 526/64; 526/65; 526/348.5; 526/905

(57) ABSTRACT

An olefin polymerization process and apparatus produce, in a single reactor, a polymer with a broad molecular weight distribution and short chain branching concentrated in the high molecular weight portion of the polymer product. A molecular weight lever, such as hydrogen, is pulsed out of phase with a short chain branching lever, such as 1-hexene, to produce a polymer product having desirable toughness characteristics and improved processability.

### RELATED APPLICATIONS

This application claims the benefit under 35 U.S.C. § 119(e) of U.S. Provisional Application No. 60/412,070 (“the '070 application”) filed on Sep. 19, 2002. The '070 application is incorporated by reference herein.

### FEDERALLY SPONSORED RESEARCH OR DEVELOPMENT

Not Applicable

### BACKGROUND OF THE INVENTION

A typical olefin polymerization reactor may operate under steady or nearly steady conditions. In such a system, reactor parameters such as temperature, rate of polymerization, catalyst feed, and reactant concentrations are usually kept as constant as possible when polymerizing a given type of polymer.

Steady operation of a polymerization reactor is desirable in many situations and for many reasons, including the use of simpler control methods, easier detection of system perturbations and mechanical problems, and minimization of the risk of major uncontrolled swings of reactor temperatures or reactant concentrations. Also, with steady state conditions, consistent polymer product is produced over time, requiring little if any downstream blending to achieve product consistency over long periods of time.

Although there are operational reasons to employ steady operation, the polymer product that is obtained may not be optimal for certain end use applications. Steady operation tends to produce a consistent, single population of molecules continuously. When only one reactor at one set of conditions is employed, it is difficult to create different molecular species (with regard to molecular weight, short chain branches, or long chain branches) during the polymerization process.

A polymer product with a broad molecular weight distribution is preferable for many applications such as melt processing, film blowing and others. For certain polymer end uses, toughness, strength, and cracking resistance are enhanced when the polymer has a relatively high molecular weight. As the molecular weight of the polymer increases, however, the processability of the resin usually decreases. However, the toughness properties of high molecular weight polymers may be retained and processability improved by providing a polymer with a broad molecular weight distribution. One example of a polymer product with a broad molecular weight distribution results from the combination of a relatively high molecular weight polymer with a relatively low molecular weight polymer. Such a polymer may be referred to as a bimodal molecular weight polymer, or simply as a bimodal polymer.

The addition of a co-monomer, such as hexene, to a polymerization process provides short chain branching on the polymer molecules. Short chain branching reduces the polymer crystallinity, reduces the polymer density, and improves the toughness of the final product. Certain properties of polymers having broad molecular weight distributions, such as film toughness and puncture resistance, are shown to be further enhanced if the high molecular weight portion of the polymer contains a relatively large degree of short chain branching, and the low molecular weight portion has a relatively low degree, or is essentially free, of short chain branching. In addition, a bimodal polymer with short chain branching in the high molecular weight portion is less soluble in the reaction diluent, which makes for improved processibility and reduces the potential for fouling. It is therefore desirable to obtain a polymer with a broad molecular weight distribution and which has short chain branching mostly in the high molecular weight portion of the polymer.

Post-reactor melt blending may be used to produce a polymer product having a broad molecular weight distribution. However, such physically blended bimodal polymers are problematic in film and other resin applications because of mixing difficulties and high gel levels. In addition, melt-blending adds an extra and costly step to the polymer manufacturing process.

Also, reaction schemes using multiple reactors in series or parallel may be used to combine separate polymer products of narrow molecular weight distribution to form a final polymer product having a bimodal molecular weight distribution. However, the building and operation of multiple reactors may be greatly expensive and complicated.

There is a need for a process and apparatus that produces a polymer product, from a single polymerization reactor, that has a broad molecular weight distribution and short chain branching in the high molecular weight portion of the molecular weight distribution. Such a reaction system would increase operational efficiency, lower costs, and improve the quality of varieties of product obtainable from a polymerization reactor. Further, greater process flexibility and therefore a wider range of polymer products may be achieved to the extent that such a single reactor system allows for control of the polymer component molecular weight, molecular weight distribution, and short chain branching.

### SUMMARY OF THE INVENTION

According to the present invention, a polymerization process is provided in which a molecular weight lever such as hydrogen is pulsed out of phase with a short chain branching lever such as 1-hexene. By pulsing the short chain branching lever out of phase with the molecular weight lever, a polymer product having a broad molecular weight distribution and the desired short chain branching in the high molecular weight portion of the polymer product is formed.

According to one aspect of the present invention, a polymerization process is provided in which olefin monomer is polymerized in a liquid diluent in a loop reaction zone to produce a fluid slurry comprising liquid diluent and solid olefin polymer particles. Hydrogen (or another molecular weight lever) is pulsed into the reaction zone. Co-monomer (or another short chain branching lever) is pulsed into the reaction zone, out of phase with the hydrogen pulse. As used herein, “molecular weight lever” can mean any substance that, if present during a polymerization reaction, tends to facilitate production of lower molecular weight polymers or any reaction parameter that may be controlled to facilitate production of lower molecular weight polymers. As used herein, “short chain branching lever” can mean any substance that, if present during a polymerization reaction, tends to facilitate production of short chain branching on the polymer.

In another aspect of the invention, hydrogen and co-monomer addition and reduction periods may be employed. In a hydrogen addition period, hydrogen is introduced to the reaction zone for a period of time (molecular weight lever addition period). Following the hydrogen addition period is a hydrogen reduction period, in which the introduction of the hydrogen is reduced or stopped for a period of time (molecular weight lever reduction period). In a co-monomer addition period, co-monomer is introduced to the reaction zone for a period of time (short chain branching lever addition period). Following the co-monomer addition period is a co-monomer reduction period, in which the introduction of co-monomer is reduced or stopped for a period of time (short chain branching lever reduction period). An addition period may be referred to as a pulse. The alternation of addition periods and reduction periods may be referred to as pulsing. The co-monomer and hydrogen pulsing may be repeated for a desired number of times during an average liquid residence time, which is commonly calculated as the reactor volume divided by the volumetric replacement rate of reactor liquid.

According to another aspect of the present invention, a polymerization process is provided which includes contacting an olefin monomer and an olefin polymerization catalyst system in a reaction zone and maintaining suitable polymerization conditions in the reaction zone. The process also includes providing short chain branching to the polymer made by the polymerization process and lowering the average molecular weight of the polymer made by the polymerization process. These may be performed during separate periods.

Objects and advantages of the invention will be apparent from the foregoing brief description of the invention and the appended claims as well as the detailed description of the invention and the drawings.

### BRIEF DESCRIPTION OF THE DRAWINGS

FIG. 1 is graphical representation of the hydrogen concentration when hydrogen is pulsed in certain olefin polymerization reaction zones.

FIG. 2 is graphical representation of the co-monomer concentration when co-monomer is pulsed in certain olefin polymerization reaction zones.

FIG. 3 is a graphical representation of the hydrogen concentration and the co-monomer concentration when hydrogen and co-monomer are each pulsed out of phase with the other in certain olefin polymerization reaction zones.

FIG. 4 is a schematic perspective view of a loop polymerization reactor in which co-monomer and hydrogen may be pulsed out of phase.

FIG. 5 is a schematic perspective view of a loop polymerization reactor in which hydrogen and co-monomer may be fed to the reactor through a single port.

FIG. 6 is a schematic perspective view of a loop polymerization reactor having multiple ports for feeding hydrogen and co-monomer staggered around the loop reactor.

### DETAILED DESCRIPTION OF THE INVENTION

The present invention relates to a process and apparatus for producing polymer having a broad molecular weight distribution and short chain branching in the high molecular weight portion of the polymer.

The present process and apparatus may be employed in a polymerization reaction system other than a slurry system or a loop reactor. For example, the present process and apparatus may be applicable to gas phase polymerizations and batch reaction systems. Nonetheless, the aspects of the invention described below are particle form polymerizations, also referred to as slurry polymerizations, and may be conducted in a loop reactor, which may be vertical or horizontal. In this technique, feed materials such as diluent, monomer and catalyst are introduced to the loop reactor to create a slurry containing solid polyolefin particles, diluent, and unreacted monomer, and a portion of the resulting slurry is taken off or withdrawn from the reactor.

In commercial loop reactors, the various feed materials may be introduced to the loop reaction zone in various ways. For example, the monomer and catalyst may be mixed with varying amounts of diluent prior to introduction to the reaction zone. In the loop reaction zone, the monomer and catalyst may become dispersed in the fluid slurry. Under some conditions, where the slurry is circulated relatively rapidly, the monomer and catalyst may become dispersed so quickly that the reactor has an essentially uniform concentration of monomer and catalyst. Under other conditions, when the slurry is circulated relatively slowly, the monomer and/or catalyst may be more concentrated in one zone than in another. As the monomers and catalyst circulate through the loop reaction zone in the fluid slurry, the monomer reacts at the catalyst site in a polymerization reaction. The polymerization reaction yields solid polyolefin particles in the fluid slurry. Other material, such as hydrogen and co-monomer, may also be introduced into the reactor. The material may be introduced at one point or at multiple points along the loop reactor.

The process and apparatus can include any olefin polymerization but one aspect of the invention utilizes a diluent so as to produce a slurry of solid polymer particles and diluent. Suitable olefin monomers may be 1-olefins having up to 8 carbon atoms per molecule and no branching nearer the double bond than the 4-position. The present method may be suitable for the copolymerization of ethylene and a higher 1-olefin co-monomer such as butene, 1-pentene, 1-hexene, 1-octene or 1-decene.

Suitable diluents (as opposed to solvents or monomers) are well known in the art and include hydrocarbons that are inert and liquid under reaction conditions. Suitable hydrocarbons include, but are not limited to, isobutane, propane, n-pentane, i-pentane, neopentane and n-hexane.

Polymerization catalysts are well known in the art. One suitable catalyst is chromium oxide on a support such as silica as broadly disclosed, for instance, in Hogan and Banks, U.S. Pat. No. 2,825,721 (March 1958), the disclosure of which is hereby incorporated by reference. Other catalysts which may be used include, but are not limited to, Ziegler catalysts, metallocenes, and other well-known polyolefin catalysts, as well as co-catalysts. The catalyst system used with one aspect of the invention includes an olefin polymerization catalyst and a co-catalyst, and is responsive to hydrogen such that lower molecular weight polymers may be created in the presence of the hydrogen. Other useful catalyst systems are described in U.S. Pat. No. 5,739,220, which is hereby incorporated by reference.

To produce a polymer product with a broad molecular weight distribution, hydrogen may be introduced into the reaction zone during a hydrogen addition period. The presence of hydrogen in a polymerization reaction will tend to produce a polymer of lower molecular weight. Lower molecular weight polymers may be produced when the hydrogen concentration is relatively high. At the desirable end of the hydrogen addition period, the flow of hydrogen into the reactor or reaction zone is reduced or halted. The hydrogen addition period may be a predetermined amount of time and/or determined based on one or more measured parameters. When the hydrogen addition period ends, a hydrogen reduction period begins, which is indicated by a lower concentration of hydrogen in the reaction medium than during the hydrogen addition period. Higher molecular weight polymers may be produced when the hydrogen concentration is relatively low. In a continuous loop reactor having one hydrogen inlet to the reactor, the alternation of hydrogen addition and reduction periods may yield a homogeneous reaction zone or may yield localized reaction zones having different hydrogen concentrations, depending on the conditions. In a continuous loop reactor where the reaction slurry is rapidly circulated, the hydrogen concentration in the reactor may be substantially homogeneous throughout the loop reactor but may vary over time according to the present invention.

Other molecular weight levers that may be used according to the present process and apparatus include specific catalysts, reaction temperature, and other substances known in the art that affect the polymer product molecular weight, such as triethylboron (TEB). For example, a catalyst that is known to produce a high molecular weight polymer may be pulsed out of sync with a catalyst that is known to produce a lower molecular weight polymer. Also, reaction temperature may be pulsed, across the reaction zone or over time, to produce a polymer having a broad molecular weight distribution.

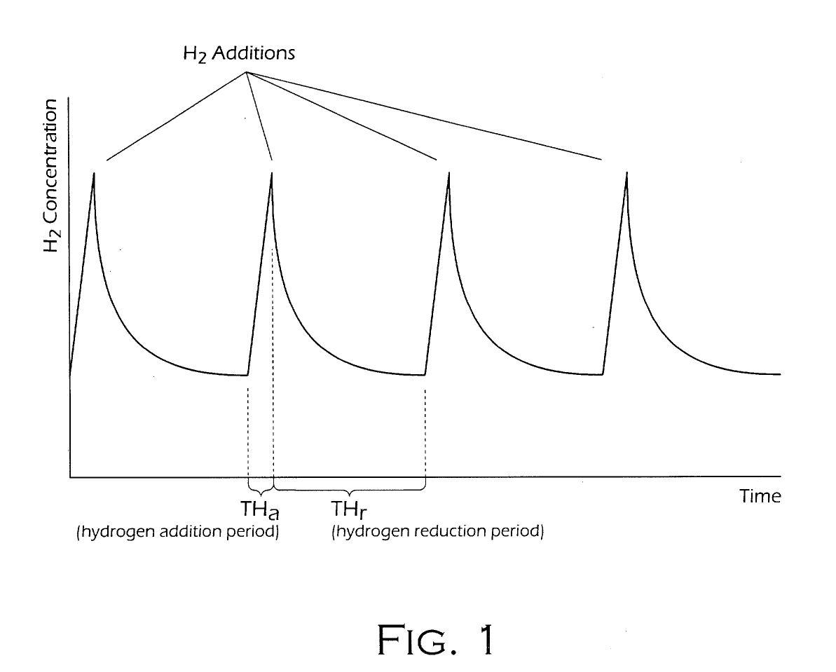

FIG. 1 is a graphical representation, according to an aspect of the present invention, of the hydrogen concentration over time in a loop reactor having rapid slurry circulation (such that the hydrogen concentration is substantially homogeneous throughout the reactor) or a batch reactor. For a hydrogen addition period, hydrogen is introduced to a reaction zone at a desired rate. After the completion of the hydrogen addition period, there is little or no introduction of hydrogen for a hydrogen reduction period THᵣ. When the periods between the maximum and minimum hydrogen concentrations are minimized, or at least kept sufficiently short, the polymerization reaction may be carried out at substantially two hydrogen concentrations, H₁ and H₂.

With respect to duration and frequency of hydrogen pulses, it may be desirable to ensure that enough time passes between each pulse so as to maximize the difference in hydrogen concentration between the minimum and maximum conditions, and thus maximize the heterogeneity (breadth of distribution) in the molecular weights produced. The rate of hydrogen concentration decline after each pulse may dictate the length of time required to allow the hydrogen concentration to fall sufficiently to accomplish the desired heterogeneity before the next hydrogen pulse is introduced. This rate of hydrogen concentration decline is a combination of the reactor content replacement rate and the hydrogen production and consumption rates (if any).

The rate of hydrogen concentration decline via simple replacement or flushing may be readily estimated using standard methods or models based on average reactor liquid residence time for a well-mixed or so-called continuous stirred tank reactor (CSTR). For an ideal CSTR, the average liquid residence time may be commonly calculated as the reactor volume divided by the volumetric replacement rate of reactor liquid. According to traditional textbook methods, the concentration of a chemical species in such a reactor can be expected to decline in a predictable mathematical manner with time expressed as a multiple of the average liquid residence time. For example, in some aspects of the invention, following a given pulse and the corresponding concentration peak, the hydrogen concentration can be expected to decline to about 30%-37% of that peak due to flushing alone, after one average liquid residence time has elapsed.

In addition to the flushing mechanism, hydrogen concentration may decline faster (or slower) if it is actually consumed (or produced) by the reaction itself. This additional mechanism of hydrogen concentration change may be influenced by several factors peculiar to the polymerization system employed. The effect of this mechanism on hydrogen concentration may be found by observation. For continuous polyethylene loop slurry processes, the hydrogen consumption (or production) factors may include, but are not limited to, the particular catalyst's rate of hydrogen consumption, catalyst activity, catalyst induction time (if any), catalyst concentration, solids concentration in the slurry, and overall reaction rate (as governed by well known parameters such as temperature, monomer concentration, etc.).

For the practical purpose of achieving a consistent product within a given quantity or container of resin (for example a rail car) or consistency from one container to another, it may be desirable to ensure that the pulses are not spaced excessively apart. In a continuous loop slurry polyethylene process for example, the inherent mixing action of the reactor itself may allow pulse spacing of 1 or 2 average liquid residence times. If some post reactor downstream mixing is performed, the pulse spacing may be increased to 2 or 3 or more average liquid residence times. Another aspect of the invention may have multiple pulses within an average liquid residence time.

The hydrogen addition period THₐ may be a duration that is less than the average liquid residence time. In one aspect of the invention, the hydrogen addition period is at most about 50% of the average liquid residence time, alternatively at most about 40%, alternatively at most about 33%, alternatively at most about 25%, alternatively at most about 20%, alternatively at most about 10%, alternatively at most about 5%, alternatively at most about 2.5%, alternatively at most about 2%, alternatively at most about 1%, alternatively at most about 0.5% of the average liquid residence time. The hydrogen addition period may be at least about 0.01%, alternatively at least about 0.05%, alternatively at least about 0.1%, alternatively at least about 0.5%, alternatively at least about 1%, alternatively at least about 2%, alternatively at least about 2.5%, alternatively at least about 5%, alternatively at least about 10%, alternatively at least about 20% of the average liquid residence time. Any minimum and any maximum period, as specified above, may be combined to define a range of periods, providing that the minimum selected is equal to or less than the maximum selected. Alternatively, the hydrogen addition period may be from about 400% of the average liquid residence time to just over 0% of the average liquid residence time.

The hydrogen reduction period THᵣ may be from just under 100% of the average liquid residence time to just over 0% of the average liquid residence time. In one aspect of the invention, the hydrogen reduction period may be at most about 50% of the average liquid residence time, alternatively at most about 40%, alternatively at most about 33%, alternatively at most about 25%, alternatively at most about 20%, alternatively at most about 10%, alternatively at most about 5%, alternatively at most about 2.5%, alternatively at most about 2%, alternatively at most about 1%, alternatively at most about 0.5% of the average liquid residence time. The hydrogen reduction period may be at least about 0.01%, alternatively at least about 0.05%, alternatively at least about 0.1%, alternatively at least about 0.5%, alternatively at least about 1%, alternatively at least about 2%, alternatively at least about 2.5%, alternatively at least about 5%, alternatively at least about 10%, alternatively at least about 20% of the average liquid residence time. Any minimum and any maximum period, as specified above, may be combined to define a range of periods, providing that the minimum selected is equal to or less than the maximum selected. Alternatively, the hydrogen reduction period may be from about 400% of the average liquid residence time to just over 0% of the average liquid residence time.

The concentration of hydrogen in the reactor may be limited by the solubility level of hydrogen in the liquid slurry at reaction temperature and pressure. When the concentration of hydrogen in the reactor reaches this solubility level, which is called the bubble point, hydrogen bubbles begin to form in the reaction slurry. These hydrogen bubbles may cause problems in reactor pumps and other equipment downstream of the reactor. It may therefore be desirable to keep the concentration of hydrogen in the reactor below the bubble point.

Furthermore, it is known that if the hydrogen concentration in the reactor becomes too high, depending on the reactor conditions, the polymer product formed may soften, swell, or even become soluble in the liquid diluent. It may therefore be desirable to keep the hydrogen concentration in the reactor below the point where such softening or swelling occurs.

To produce short chain branching in the high molecular weight component of the resulting polymer product, co-monomer may be pulsed into the reactor, out of phase with the hydrogen pulse, during a co-monomer addition period. In this aspect of the invention, the timing of the co-monomer pulse is arranged such that the co-monomer concentration in the reactor or in a portion of the fluid slurry is at a maximum when the hydrogen concentration is close to its minimum. Although 1-hexene is used in this aspect of the invention, any other co-monomer known in the art for producing short chain branching in a polymerization process may be used. Such co-monomers include, but are not limited to, butene, 1-pentene, 1-hexene, 1-octene or 1-decene. After the co-monomer addition period, a co-monomer reduction period may follow, during which less, or no co-monomer is introduced to the reactor.

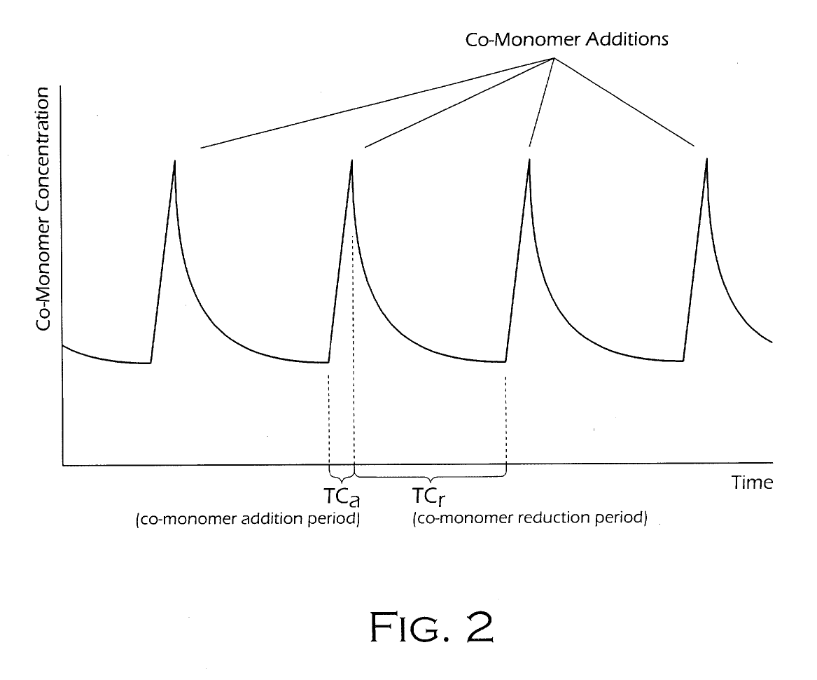

FIG. 2 is a graphical representation, according to an aspect of the present invention, of the co-monomer concentration over time in a loop reactor having rapid slurry circulation (such that the co-monomer concentration is substantially homogeneous throughout the reactor) or a batch reactor. In the co-monomer addition step, co-monomer is introduced to the reaction zone, out of phase with the hydrogen addition step, at a desired co-monomer addition level. Following the co-monomer addition period is the co-monomer reduction period, in which the introduction of the co-monomer is reduced or stopped for a co-monomer reduction period TCᵣ. When the periods between the maximum and minimum co-monomer concentrations are minimized, or at least kept sufficiently short, the reaction may be carried out at substantially two co-monomer concentrations C₁ and C₂. In one aspect of the invention, C₂ may be as small as possible (for example, essentially zero) when the maximum hydrogen concentration H₁ is present.

With respect to duration and frequency of co-monomer pulses, it may be desirable to ensure that short chain branching is maximized in the high molecular weight component and minimized in the low molecular weight component. This may be accomplished by pulsing the co-monomer out of phase with the hydrogen pulses. As a result, the frequency of the co-monomer pulses may be substantially the same as the frequency of the hydrogen pulses. The rate of co-monomer concentration decline, like the rate of hydrogen concentration decline, is a combination of the reactor content replacement rate and the co-monomer production and consumption rates.

Like hydrogen consumption, co-monomer consumption may be influenced by several factors peculiar to the polymerization system employed. The effect on co-monomer concentration may be found by observation. For continuous polyethylene loop slurry processes, the co-monomer consumption factors may include, but are not limited to, the particular catalyst's rate of co-monomer consumption (and production, if any), catalyst activity, catalyst induction time (if any), catalyst concentration, solids concentration in the slurry, and overall reaction rate (as governed by well known parameters such as temperature, monomer concentration, etc.).

The co-monomer addition period TCₐ may be a duration that is less than the average liquid residence time. In one aspect of the invention, the co-monomer addition period is at most about 50% of the average liquid residence time, alternatively at most about 40%, alternatively at most about 33%, alternatively at most about 25%, alternatively at most about 20%, alternatively at most about 10%, alternatively at most about 5%, alternatively at most about 2.5%, alternatively at most about 2%, alternatively at most about 1%, alternatively at most about 0.5% of the average liquid residence time. The co-monomer addition period may be at least about 0.01%, alternatively at least about 0.05%, alternatively at least about 0.1%, alternatively at least about 0.5%, alternatively at least about 1%, alternatively at least about 2%, alternatively at least about 2.5%, alternatively at least about 5%, alternatively at least about 10%, alternatively at least about 20% of the average liquid residence time. Any minimum and any maximum period, as specified above, may be combined to define a range of periods, providing that the minimum selected is equal to or less than the maximum selected. Alternatively, the co-monomer addition period may be from about 400% of the average liquid residence time to just over 0% of the average liquid residence time.

The co-monomer reduction period TCᵣ may be from just under 100% of the average liquid residence time to just over 0% of the average liquid residence time. In one aspect of the invention, the co-monomer reduction period is at most about 50% of the average liquid residence time, alternatively at most about 40%, alternatively at most about 33%, alternatively at most about 25%, alternatively at most about 20%, alternatively at most about 10%, alternatively at most about 5%, alternatively at most about 2.5%, alternatively at most about 2%, alternatively at most about 1%, alternatively at most about 0.5% of the average liquid residence time. The co-monomer reduction period may be at least about 0.01%, alternatively at least about 0.05%, alternatively at least about 0.1%, alternatively at least about 0.5%, alternatively at least about 1%, alternatively at least about 2%, alternatively at least about 2.5%, alternatively at least about 5%, alternatively at least about 10%, alternatively at least about 20% of the average liquid residence time. Any minimum and any maximum period, as specified above, may be combined to define a range of periods, providing that the minimum selected is equal to or less than the maximum selected. Alternatively, the co-monomer reduction period may be from about 400% of the average liquid residence time to just over 0% of the average liquid residence time.

The pulse spacing, hydrogen addition and reduction periods, and co-monomer addition and reduction periods of the present invention may also be expressed as a percentage of the average solids residence time, which is defined as the average time that a polymer particle spends in the reactor.

The amount of co-monomer in the reactor may be expressed as a percentage of the monomer being fed. In typical steady state polymerization systems, the co-monomer fed to the reactor may be from about 0% to about 20% of the monomer being fed to the reactor, and in certain situations from about 0% to about 50% of the monomer being fed to the reactor, during a given time period. With the pulsed loop reactor system, higher concentrations of co-monomer may also be used depending on the type of product desired. For example, during the co-monomer addition period, the co-monomer fed to the reactor may be up to 100% of the monomer being fed to the reactor during the same period. Alternatively, for certain aspects of the present invention, the co-monomer being fed may be greater than 100% of the monomer being fed, to the point where there is substantially no monomer fed during the co-monomer addition period. The concentration of the co-monomer in the reactor, however, is subject to normal operating limits. When the co-monomer concentration reaches a certain limit, depending on other reaction conditions, the polymer product may begin to soften or swell. If co-monomer concentrations exceed this limit, the polymer product formed may become soluble in the diluent. It therefore may be desirable to keep the co-monomer concentration below the point where the polymer product begins to soften or swell.

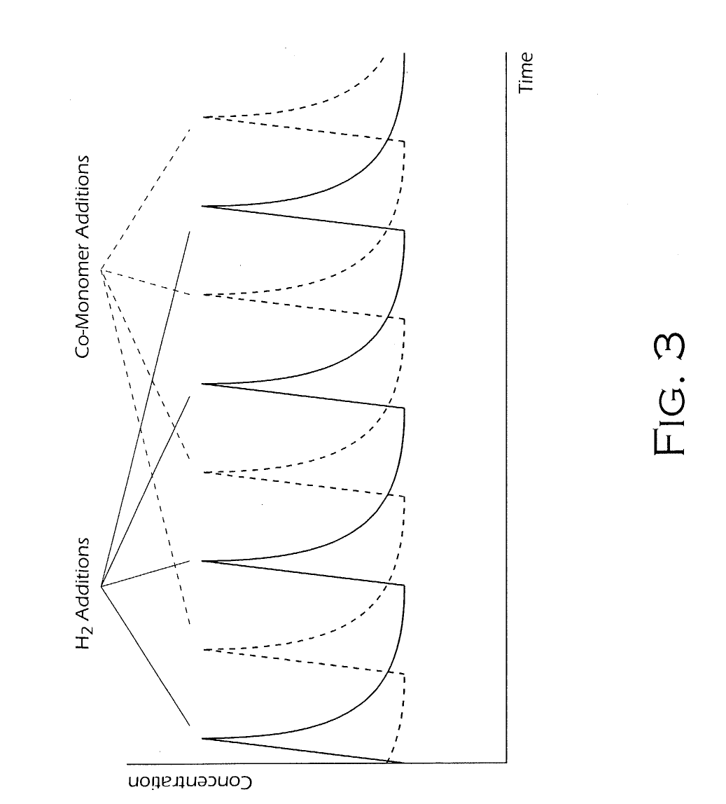

FIG. 3 is a graphical representation, according to an aspect of the present invention, of the hydrogen concentration and the co-monomer concentration over time in a rapidly circulated loop reactor or batch reactor. The hydrogen and co-monomer have been pulsed out of phase such that the co-monomer concentration is at a maximum when the hydrogen concentration is at or near its minimum, and the hydrogen concentration is at a maximum when the co-monomer concentration is at or near its minimum. For the aspect of the invention depicted in FIG. 3, the hydrogen and co-monomer addition rates are shown to be linear while the hydrogen and co-monomer reduction rates are shown to be non-linear. In other aspects of the invention, the addition and reduction rates may resemble different functions, depending on the desired control scheme of the reaction system. Also, the present invention is not limited to pulsing in any specific order. Therefore, the present invention may include a process in which the hydrogen (or molecular weight lever) is pulsed first or a process in which the co-monomer (or short chain branching lever) is pulsed first.

In one aspect of the invention, for batch reactors, at least two pulses each of co-monomer and hydrogen are made to the reactor during the average liquid residence time in the polymerization batch reactor. In another aspect of the invention, at least three pulses of co-monomer and hydrogen are made to the reactor during the average liquid residence time. In another aspect of the invention, at least four pulses of co-monomer and hydrogen are made to the reactor during the average liquid residence time. For continuous polymerization, the amount of time for the pulses of co-monomer and hydrogen may be less than the average liquid residence time. Generally at least two, alternatively at least three, and alternatively at least four pulses of co-monomer and hydrogen may be made within the average liquid residence time. The frequency and amplitude of the pulses are determined based on the desired polymer product to be made.

In another aspect of the present invention, a polymerization process may be provided which comprises contacting an olefin monomer and an olefin polymerization catalyst system in a reactor and maintaining suitable polymerization conditions throughout the reactor. The process includes providing a first reaction zone in the reactor where a first polymer is made, said first polymer being characterized by a relatively high molecular weight and a relatively high content of short chain branching. The process also includes providing a second reaction zone in the reactor where a second polymer is made, said second polymer being characterized by a relatively low molecular weight and a relatively low content of short chain branching. The process includes mixing the first polymer and the second polymer within the reactor.

In another aspect of the present invention, a loop reactor apparatus is provided. The loop reactor apparatus comprises a plurality of major segments and a plurality of minor segments. Each of the major segments may be connected at one end to one of the minor segments and may be connected at an opposite end to another minor segment, such that the major and minor segments form a continuous flow path adapted to convey a fluid slurry. The reactor is substantially free from internal obstructions. The loop reactor apparatus may also include means for introducing a co-monomer into said continuous flow path and means for introducing hydrogen into said continuous flow path. Each of the means for introducing a co-monomer may be distanced at least half the length of a major segment from each of the means for introducing hydrogen.

In another aspect of the invention, a loop reactor apparatus is provided. The loop reactor apparatus comprises a plurality of major segments and a plurality of minor segments. Each of the major segments may be connected at one end to one of the minor segments and may be connected at an opposite end to another minor segment, such that the major and minor segments form a continuous flow path adapted to convey a fluid slurry. The reactor is substantially free from internal obstructions. The apparatus includes a means for pulsing a co-monomer and hydrogen into said continuous flow path. The means does not pulse co-monomer and hydrogen simultaneously.

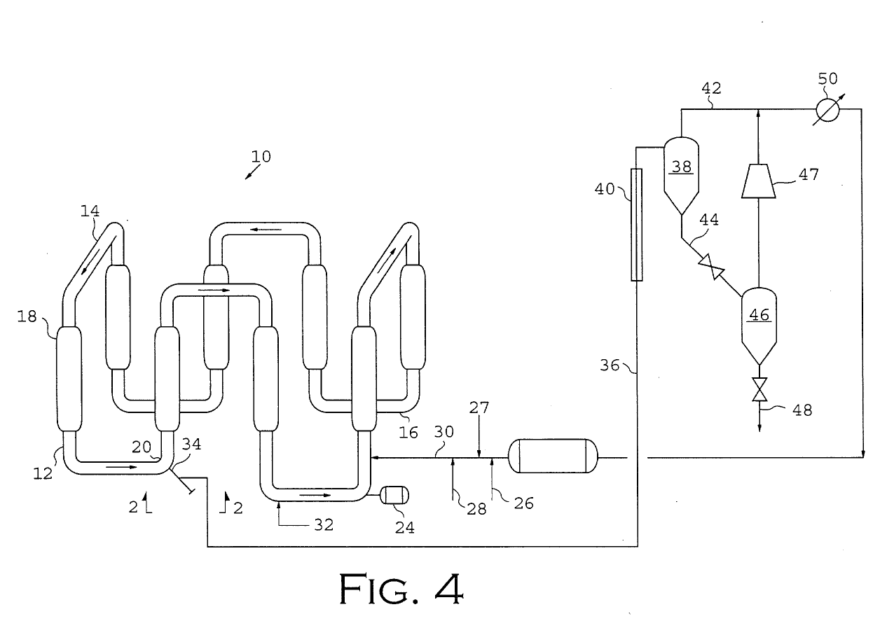

FIG. 4 shows a schematic perspective view of a polymerization reaction system that may be used in an aspect of this invention. A loop reactor 10 is shown having vertical segments 12 (the major segments of loop reactor 10), upper horizontal segments 14 and lower horizontal segments 16 (the minor segments of loop reactor 10). These upper and lower horizontal segments define upper and lower zones of horizontal flow. In this aspect of the invention, the loop reactor has eight vertical segments, although it is contemplated that the present process may be used with a loop reactor having a higher or lower number of vertical segments. The reactor may be cooled by means of heat exchangers formed by a pipe and jacket.

Each segment or leg may be connected to the next segment or leg by a smooth bend or elbow 20 thus providing a continuous flow path substantially free from internal obstructions. The fluid slurry may be circulated and mixed by means of an impeller (not shown) driven by a motor 24. Monomer, co-monomer and hydrogen may be introduced via lines 26, 27, and 28 respectively which can enter the reactor directly at one location or a plurality of locations or can combine with condensed diluent recycle line 30. Catalyst may be introduced via catalyst introduction means 32 that provides a zone (location) for catalyst introduction.

In this aspect of the invention, a continuous take off mechanism 34 may be located in or adjacent to a downstream end of one of the lower horizontal reactor loop sections 16 and adjacent or on a connecting elbow. The continuous take off mechanism may also be located on any segment or any elbow. Take off mechanisms that are not continuous, such as settling legs, may also be used. Settling legs as set forth in U.S. Pat. No. 5,183,866 (incorporated by reference) may be used to withdraw slurry.

Product slurry may be withdrawn through the continuous take off mechanism 34 and passed via conduit 36 into a high pressure flash chamber 38. Conduit 36 may include a surrounding conduit 40 that is provided with a heated fluid which provides indirect heating to the slurry material in flash line conduit 36. Vaporized diluent exits the flash chamber 38 via conduit 42 for further processing which may include condensation by simple heat exchange using recycle condenser 50, and return to the system, without the necessity for compression, via recycle diluent line 30. Recycle condenser 50 can utilize any suitable heat exchange fluid known in the art under any conditions known in the art. A fluid at a temperature that can be economically provided may be used. A suitable temperature range for this fluid may be about 40 degrees F. to about 130 degrees F. Polymer particles are withdrawn from high pressure flash chamber 38 via line 44 for further processing using techniques known in the art. In one aspect of the invention, they are passed to low pressure flash chamber 46 and thereafter recovered as polymer product via line 48. Separated diluent may pass through compressor 47 to line 42. The choice of downstream diluent separation apparatus is not critical.

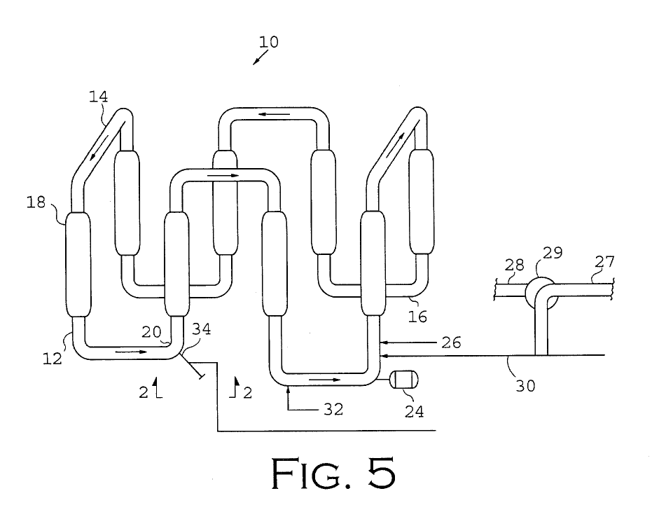

FIG. 5 shows a schematic perspective view of another polymerization reaction system that may be used in an aspect of this invention. As in FIG. 4, a loop reactor 10 is shown with eight vertical segments 12, four upper horizontal segments 14 and four lower horizontal segments 16. Each segment or leg may be connected to the next segment or leg by a smooth bend or elbow 20. The fluid slurry may be circulated and mixed by means of an impeller (not shown) driven by a motor 24. Monomer may be introduced via line 26. Co-monomer line 27 and hydrogen line 28 lead to a valve 29, which permits either co-monomer or hydrogen (but not both) to be fed to the reactor via condensed diluent recycle line 30 as shown or with make-up diluent. Catalyst may be introduced via catalyst introduction means 32. The downstream diluent separation apparatus of FIG. 4, or other apparatus, are subsequently used.

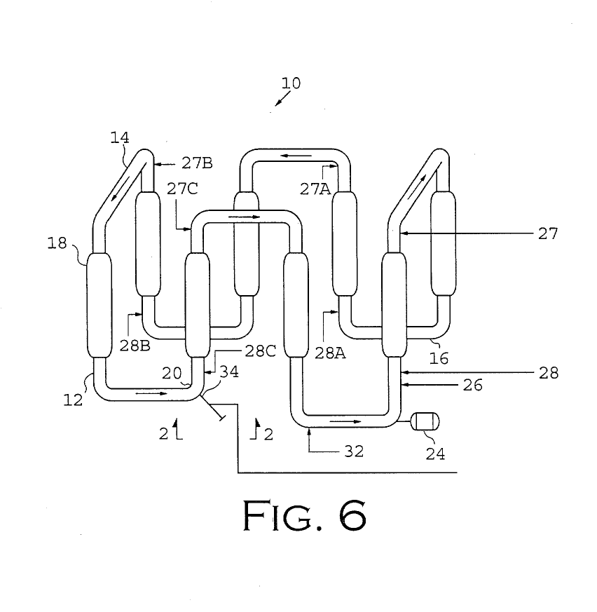

FIG. 6 shows a schematic perspective view of yet another polymerization reaction system that may be used in an aspect of this invention. As in FIG. 4, a loop reactor 10 is shown with eight vertical segments 12, four upper horizontal segments 14 and four lower horizontal segments 16. Each segment or leg may be connected to the next segment or leg by a smooth bend or elbow 20. The fluid slurry may be circulated and mixed by means of impeller (not shown) driven by a motor 24. Monomer is introduced via line 26. Co-monomer lines 27, 27A, 27B, and 27C may be staggered symmetrically around the loop reactor 10. Hydrogen lines 28, 28A, 28B, and 28C may also be staggered symmetrically around the loop reactor 10. The co-monomer lines and hydrogen lines may be at opposite ends of various vertical segments 12, so that a substantial portion, alternatively essentially all, of the co-monomer will be incorporated into polymer particles before the slurry reaches the next hydrogen line. In one aspect of the invention, the reaction rates and slurry circulation velocity may be such that essentially all the hydrogen is consumed before the slurry reaches the co-monomer line that feeds co-monomer to the reactor. Additionally, or alternatively, essentially all the co-monomer is consumed before the slurry reaches the next hydrogen line. Condensed diluent recycle line 30 and catalyst introduction means 32 are also shown. The downstream diluent separation apparatus of FIG. 4, or other apparatus, are subsequently used.

The present invention may be applicable to a large variety of control configurations that may be utilized to accomplish the purpose of this invention.

While this invention has been described in detail for the purpose of illustration, it is not to be construed as limited thereby, but is intended to cover all changes within the spirit and scope thereof.

That which is claimed is:

1. A polymerization process comprising:
(a) polymerizing in a reactor at least one olefin monomer in a liquid diluent to produce a fluid slurry comprising liquid diluent and solid olefin polymer particles;
(b) withdrawing from the reactor at least a portion of said fluid slurry;
(c) introducing a short chain branching lever to the reactor for a short chain branching lever addition period; and
(d) after the end of the short chain branching lever addition period, introducing a molecular weight lever to the reactor for a molecular weight lever addition period.

2. The process of claim 1, wherein the short chain branching lever is a co-monomer.

3. The process of claim 1, wherein the short chain branching lever is 1-hexene.

4. The process of claim 1, wherein the molecular weight lever is hydrogen.

5. The process of claim 1, wherein the short chain branching lever addition period and the molecular weight lever addition period are each less than the average liquid residence time.

6. The process of claim 1 wherein the short chain branching lever addition period and the molecular weight lever addition period are each less than half the average liquid residence time.

7. The process of claim 1 wherein steps (c) and (d) are repeated at least two times during the average liquid residence time.

8. The process of claim 1 wherein steps (c) and (d) are repeated at least three times during the average liquid residence time.

9. The process of claim 1 wherein steps (c) and (d) are repeated at least four times during the average liquid residence time.

10. The process of claim 7 wherein the molecular weight lever addition period is less than 20% of the average liquid residence time.

11. The process of claim 7 wherein the short chain branching lever addition period is less than 20% of the average liquid residence time.

12. A polymerization process comprising:
(a) polymerizing in a reactor at least one olefin monomer in a liquid diluent to produce a fluid slurry comprising liquid diluent and solid olefin polymer particles;
(b) withdrawing from the reactor at least a portion of said fluid slurry;
(c) introducing co-monomer to the reactor for a co-monomer addition period; and
(d) after the co-monomer addition period, introducing hydrogen to the reactor for a hydrogen addition period.

13. The polymerization process of claim 12, wherein the reactor is a batch reactor.

14. The polymerization process of claim 12 wherein (c) and (d) are repeated at least two times during the average liquid residence time.

15. The polymerization process of claim 12 wherein (c) and (d) are repeated at least three times during the average liquid residence time.

16. The polymerization process of claim 12 wherein (c) and (d) are repeated at least four times during the average liquid residence time.

17. The polymerization process of claim 12 wherein the reactor is a loop polymerization reactor, and the co-monomer and the hydrogen are introduced at substantially the same location.

18. The polymerization process of claim 12 wherein the reactor is a loop polymerization reactor, and the process further comprises circulating the fluid slurry in the reactor.

19. The polymerization process of claim 18 wherein the hydrogen concentration throughout the slurry is essentially homogeneous.

20. A polymerization process comprising:
(a) contacting an olefin monomer and an olefin polymerization catalyst system in a reaction zone;
(b) maintaining suitable polymerization conditions in the reaction zone;
(c) providing short chain branching to the polymer made by the polymerization process; and
(d) lowering the average molecular weight of the polymer made by the polymerization process;
wherein step (c) and step (d) are mostly performed during separate periods.

21. A polymerization process for making a polyolefin, said process comprising:
(a) contacting an olefin monomer and an olefin polymerization catalyst system in a reactor;
(b) maintaining suitable polymerization conditions throughout the reactor;
(c) providing a first reaction zone in the reactor where a first polymer is made, said first polymer being characterized by a relatively high molecular weight and a relatively high content of short chain branching;
(d) providing a second reaction zone in the reactor where a second polymer is made, said second polymer being characterized by a relatively low molecular weight and a relatively low content of short chain branching; and
(e) mixing the first polymer and the second polymer within the reactor.

22. The process of claim 21, wherein the step of providing the first reaction zone comprises introducing a co-monomer to the reactor.

23. The process of claim 21, wherein the step of providing the second reaction zone comprises introducing hydrogen to the reactor.

24. The process of claim 21, wherein the reactor is a loop reactor, and a plurality of said first and second reaction zones are provided in an alternating manner around the loop reactor.

25. A loop reactor apparatus comprising:
a plurality of major segments;
a plurality of minor segments;
wherein each of said major segments is connected at one end thereof to one of said minor segments, and is connected at an opposite end thereof to another minor segment such that said major segments and said minor segments form a continuous flow path adapted to convey a fluid slurry, said reactor being substantially free from internal obstructions;
means for introducing a co-monomer into said continuous flow path;
means for introducing hydrogen into said continuous flow path;
wherein each of said means for introducing a co-monomer is distanced at least half the length of a major segment from each of said means for introducing hydrogen.

26. A loop reactor apparatus comprising:
a plurality of major segments;
a plurality of minor segments;
wherein each of said major segments is connected at one end thereof to one of said minor segments, and is connected at an opposite end thereof to another minor segment such that said major segments and said minor segments form a continuous flow path adapted to convey a fluid slurry, said reactor being substantially free from internal obstructions;
means for pulsing a co-monomer and hydrogen into said continuous flow path and for avoiding pulsing co-monomer and hydrogen simultaneously.
